(19) United States
(12) Patent Application Publication
(10) Pub. No.: US 2026/0064029 A1
(43) Pub. Date: Mar. 5, 2026

(54) SCANNING OPTICAL DEVICE AND IMAGE FORMING APPARATUS

(71) Applicant: CANON KABUSHIKI KAISHA, Tokyo (JP)

(72) Inventors: ICHIRO FUKADA, Shizuoka (JP); HIROYUKI FUKUHARA, Shizuoka (JP); TOSHINORI SHIRATORI, Shizuoka (JP)

(21) Appl. No.: 19/297,818

(22) Filed: Aug. 12, 2025

(30) Foreign Application Priority Data
Sep. 3, 2024 (JP) 2024-151757

(51) Int. Cl. G03G 15/04; G03G 21/16

(52) U.S. Cl. CPC G03G 15/0409; G03G 15/04072; G03G 21/1633; G03G 2215/0404; G03G 2221/169

(57) ABSTRACT

A scanning optical device includes a polygon mirror, an optical box accommodating the polygon mirror, and a cover covering an opening of the optical box. On an opposite surface of the cover, a plurality of ribs projected toward the polygon mirror are formed. As viewed in a rotational axis direction of the polygon mirror, the ribs are disposed so as to have rotational symmetry about a rotational axis, extended from the axis toward a circumscribing circle of the polygon mirror, and disposed at positions apart from a distance in upstream or downstream side in the rotational direction to imaginary lines, of the same number as that of the ribs, having rotational symmetry about the rotational axis. Each of ribs has a lengthy shape parallel to the corresponding imaginary line, one end portion thereof is disposed outside and the other end portion thereof is disposed inside the circumscribing circle.

### BACKGROUND

### Field of the Technology

The present invention relates to a scanning optical device and an image forming apparatus, and for example, a scanning optical device that performs optical writing using a laser beam in an image forming apparatus such as a laser beam printer, a digital copier, or a digital facsimile.

### Description of the Related Art

Scanning optical device are used in electrophotographic type image forming apparatuses. In the scanning optical device, a light beam emitted from a semiconductor laser is deflected and scanned by a rotational polygon mirror, and the deflected and scanned light beam is guided onto a photosensitive member by optical components such as lenses and mirrors. This allows an electrostatic latent image to be formed on the photosensitive member. The rotational polygon mirror is rotated when deflecting and scanning the light beam inside a casing (hereinafter referred to as optical box). Further, as image forming apparatuses have become faster in recent years, there is an increasing demand for rotational polygon mirrors of scanning optical devices to rotate at high speed. When the rotational polygon mirror is rotated at high speed, an operation sound (hereinafter referred to as wind noise or rotation sound) caused by the rotational polygon mirror becomes louder, which poses a problem of impairing quietness. One of the causes of the rotation sound is air flow circulating in an annular shape (hereinafter referred to as vortex flow) about a rotational axis of the rotational polygon mirror, which is generated when the rotational polygon mirror is rotated. The vortex flow is generated when air that is pushed out by the rotation of the rotational polygon mirror is drawn upward toward the vicinity of the rotation center, which has become negative pressure as a result of the rotation. As a coping method for the generation of vortex flow, a configuration has been proposed in which ribs near the rotational polygon mirror protrude from a cover member of the scanning optical device and block (divide) the vortex flow generated by the rotation of the rotational polygon mirror, thereby improving quietness. The ribs may be configured in the form of a cross (Japanese Patent No. 6579329), or configured so that a plurality of independent ribs are disposed radially from a rotational axis center of the rotational polygon mirror (Japanese Laid-Open Patent Application (JP-A) H10-123447).

However, in the conventional example, there is a problem in that fluid fluctuation (pressure fluctuation), which is the cause of the wind noise (rotation sound) generated by the rotation of the rotational polygon mirror, becomes large, and the rotation sound increases. The reason for the increase of fluid fluctuation (pressure fluctuation) is as follows. The air that is pushed out by a corner portion formed by adjacent reflecting surfaces of the rotational polygon mirror when the rotational polygon mirror is rotated is drawn upward toward the rotational axis center of the rotational polygon mirror, which has become negative pressure a result of the rotation. The rising air then hits the cover member and descends again, and is blown toward the vicinity of the corner portion (edge portion) formed by the top surface and the reflecting surfaces of the rotational polygon mirror. This strengthens the flow (shear flow) descending with respect to a rotational axis direction of the rotational polygon mirror.

### SUMMARY

The present invention is made under such a situation to provide an inexpensive structure that aims to improve quietness by simultaneously divide the vortex flow generated by the rotation of the rotational polygon mirror and suppressing wind blowing against an edge portion of the rotational polygon mirror.

In order to solve the above-mentioned problem, the present invention has the following configuration. According to an aspect of the present invention, there is provided a scanning optical device comprising: a light source configured to emit a light beam; a rotational polygon mirror configured to deflect and scan the light beam emitted from the light source; a scanning lens configured to image the light beam deflected and scanned by the rotational polygon mirror on a scanned surface; an optical box including an opening and configured to accommodate the light source, the rotational polygon mirror, and the scanning lens; and a cover configured to cover the opening, wherein on an opposite surface of the cover opposed to the rotational polygon mirror in a state in which the cover covers the opening, a plurality of ribs projected from the opposite surface toward the rotational polygon mirror are formed, wherein as viewed in a rotational axis direction of the rotational polygon mirror, the plurality of ribs are disposed so as to have rotational symmetry about a rotational axis of the rotational polygon mirror, extended from the rotational axis toward a circumscribing circle of the rotational polygon mirror, and disposed at positions apart from a predetermined distance in an upstream side or a downstream side with respect to a rotational direction of the rotational polygon mirror to a plurality of imaginary lines, of the same number as a number of the plurality of ribs, having rotational symmetry about the rotational axis, and wherein as viewed in the rotational axis direction, each of ribs has a lengthy shape parallel to the imaginary line corresponding to each of ribs, one end portion thereof in a longitudinal direction of the rib is disposed outside the circumscribing circle and the other end portion thereof in the longitudinal direction of the rib is disposed inside the circumscribing circle.

Further features of the present disclosure will become apparent from the following description of exemplary embodiments with reference to the attached drawings.

### BRIEF DESCRIPTION OF THE DRAWINGS

FIG. 1 is a diagram showing a configuration of a scanning optical device according to embodiments 1 and 2.

FIG. 2 is a diagram showing a cover member of the scanning optical device according to embodiment 1.

FIG. 3 is a diagram showing an assembly of the cover member of the scanning optical device according to embodiments 1 and 2.

Parts (a) and (b) of FIG. 4 are diagrams showing a positional relationship between rectifying plates and a rotational polygon mirror in embodiment 1.

Parts (a), (b), (c), and (d) of FIG. 5 are diagrams showing air flow generated when the rotational polygon mirror in embodiment 1 is rotated.

Parts (a) and (b) of FIG. 6 are diagrams showing the air flow generated near the rectifying plates in embodiment 1 and a comparative example.

Parts (a) and (b) of FIG. 7 are diagrams showing the air flow generated when the rotational polygon mirror in embodiment 1 and the comparative example is rotated.

FIG. 8 is a graph showing a result of a noise measurement test in embodiment 1 and the comparative example.

Part (a) of FIG. 9 is a diagram showing the positional relationship between the rectifying plates and the rotational polygon mirror in embodiment 2, and part (b) of FIG. 9 is a diagram showing the air flow generated near the rectifying plates.

FIG. 10 is a diagram showing a configuration of an image forming apparatus according to embodiment 3.

### DESCRIPTION OF THE EMBODIMENTS

Embodiments of a scanning optical device pertaining to the present invention will be specifically described.

### Embodiment 1

### [Scanning Optical Device]

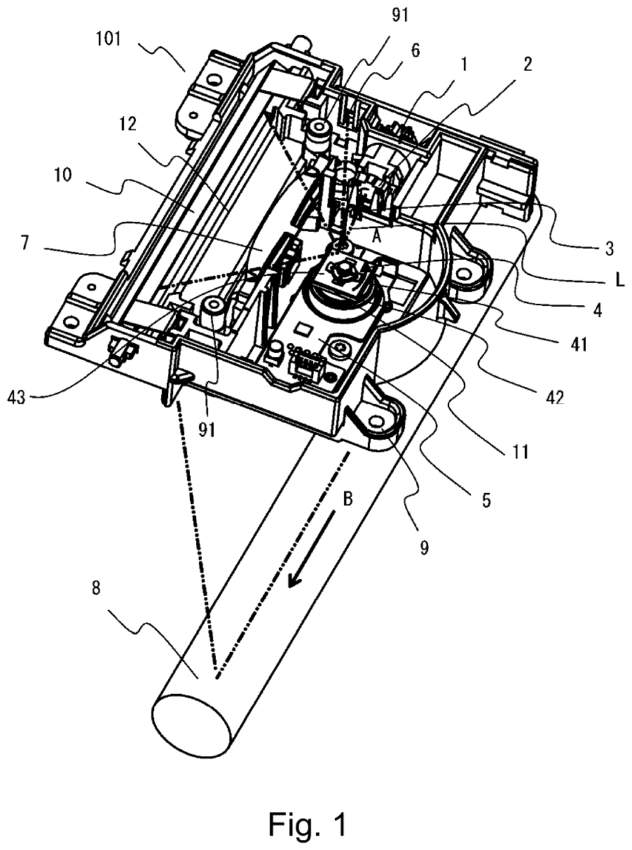

FIG. 1 is a perspective view showing a configuration of the scanning optical device according to embodiment 1. A scanning optical device 101 shown in FIG. 1 uses a laser light (light beam) to form an electrostatic latent image on a surface (scanned surface) of a photosensitive drum 8 as an image bearing member in an image forming apparatus such as a laser beam printer, a digital copier, or a facsimile. The scanning optical device 101 is provided with a semiconductor laser unit 1 as a light source for emitting a laser beam L, and an anamorphic collimator lens 2 in which a collimator lens and a cylindrical lens are integrally formed.

The scanning optical device 101 is provided with a main scanning aperture 3 having a through groove, and a rotational polygon mirror 4 in the shape of a regular quadrangular prism. The rotational polygon mirror 4 is provided with reflecting surfaces 11 for reflecting the laser beam L. In embodiment 1, the rotational polygon mirror 4 includes four reflecting surfaces 11, but the number of reflecting surfaces 11 is not limited to this. The rotational polygon mirror 4 is provided with a top surface 43 of the rotational polygon mirror 4, and an edge portion 41 which is a corner portion formed by the top surface 43 and the reflecting surfaces 11. The rotational polygon mirror 4 includes a corner portion 42 formed by the reflecting surfaces 11.

The scanning optical device 101 is provided with an optical deflector 5 that rotates the rotational polygon mirror 4 by a motor that is a driving source. The scanning optical device 101 is provided with a beam detector (hereinafter referred to as BD) 6 as a detection means for the laser beam L deflected and scanned by the optical deflector 5 in order to determine a writing start position of the laser beam L on the surface of the photosensitive drum 8. The scanning optical device 101 is provided with a scanning lens 7 as an imaging means for imaging the deflected and scanned laser beam L on the surface (scanned surface) of the photosensitive drum 8, and a folding mirror 10 for deflecting the laser beam L that has passed through the scanning lens 7 toward the photosensitive drum 8.

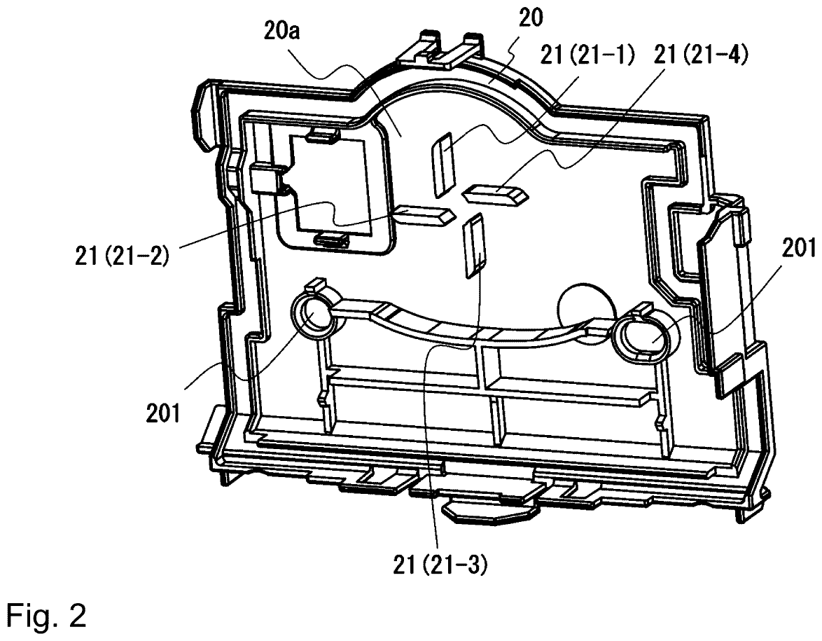

The scanning optical device 101 is provided with an optical box 9 and a cover member 20 (cover) (see FIG. 2). The optical box 9 is the casing that accommodates each of the above-mentioned optical members including the optical deflector 5, and is provided with an opening through which each of the above-mentioned optical components pass when they are installed on a bottom or side surfaces of the optical box 9. The optical box 9 is made of black resin and is formed by injection molding. The optical box 9 is provided with a positioning portion 91 that determines a relative position with respect to the cover member 20 that covers the opening of the optical box 9. The optical box 9 is provided with an emission port 12 for emitting the laser light to the outside.

A direction in which the laser beam L is scanned by the optical deflector 5 is defined as a main scanning direction, and a direction perpendicular to the main scanning direction is defined as a subscanning direction. The operation of the scanning optical device 101 will be described below.

The laser beam L emitted from the semiconductor laser unit 1 is made into a substantially parallel light or a convergent light in the main scanning direction by the anamorphic collimator lens 2, and into a convergent light in the subscanning direction. Next, the beam width of the laser beam L in the main scanning direction is limited by the main scanning aperture 3. Incidentally, the beam width in the subscanning direction is limited by the opening hole (subscanning aperture, not shown) located upstream of the anamorphic collimator lens 2. The beam that passes through the subscanning aperture, the anamorphic collimator lens 2, and the main scanning aperture 3 is imaged on the reflecting surfaces 11 of the rotational polygon mirror 4 in a focal line that extends in the main scanning direction.

The laser beam L imaged on the reflecting surfaces 11 of the rotational polygon mirror 4 is deflected and scanned by the rotational polygon mirror 4 that is rotated in the direction of an arrow A. The deflected and scanned laser beam L scans the BD 6 in the main scanning direction. Next, the deflected and scanned laser beam L enters the scanning lens 7. The laser beam L focused on the rotational polygon mirror 4 in a focal line forms spots of several mm on the scanning lens 7 and passes through the scanning lens 7. The laser beam L that passes through the scanning lens 7 is deflected by the folding mirror 10 and emitted from the emission port 12 to the outside of the scanning optical device 101.

The laser beam L emitted to the outside of the scanning optical device 101 finally images spots on the photosensitive drum 8 while scanning in the direction of an arrow B in FIG. 1. Here, the photosensitive drum 8 is rotated about its cylindrical axis to perform subscanning. This allows the electrostatic latent image corresponding to image information to be formed on the surface of the photosensitive drum 8, which is uniformly charged by a charging means (not shown).

### [Cover Member]

FIG. 2 is an explanatory diagram of the cover member 20 which is assembled to the optical box 9 in the scanning optical device 101 shown in FIG. 1, and which covers the opening of the optical box 9 that accommodates each optical member. An opposite surface of the cover member 20 opposed to the rotational polygon mirror 4 in a state in which the cover member 20 covers the opening of the optical box 9 is referred to as a ceiling wall surface 20a. It can also be said that the ceiling wall surface 20a opposes the opening of the optical box 9. Rectifying plates 21 (ribs 21-1 to 21-4) are formed on the ceiling wall surface 20a. Further, the cover member 20 is also provided with a positioning portion 201 for accurately positioning with respect to the optical box 9.

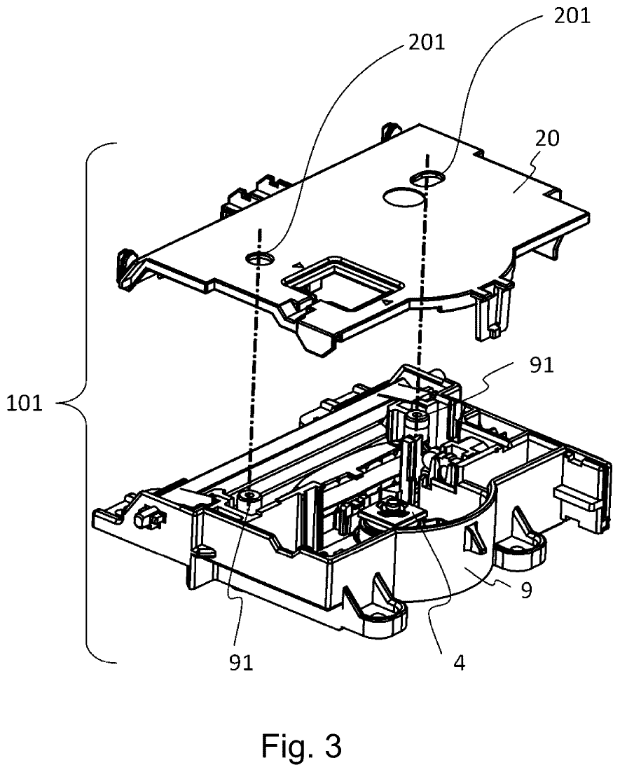

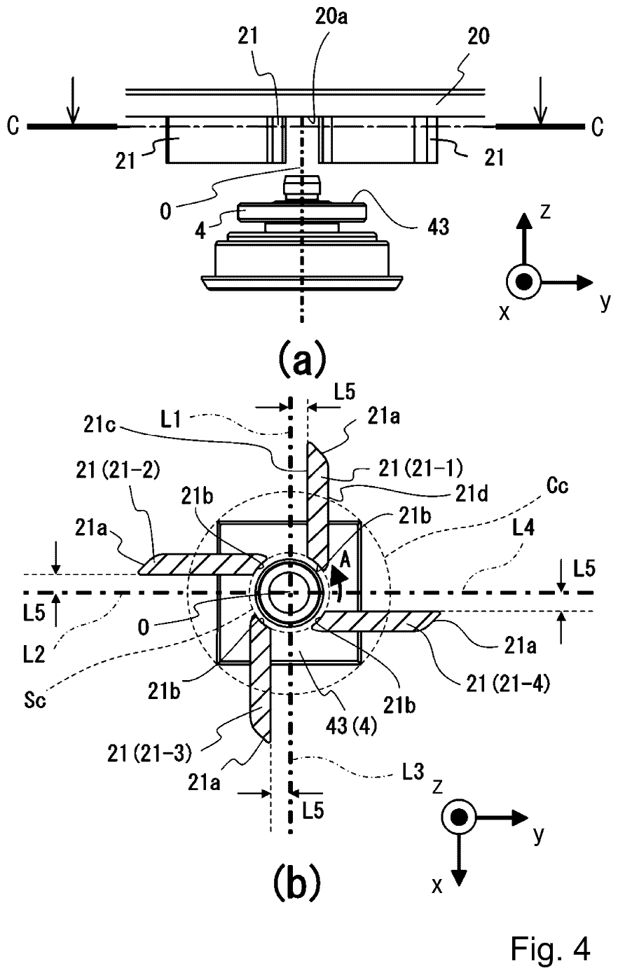

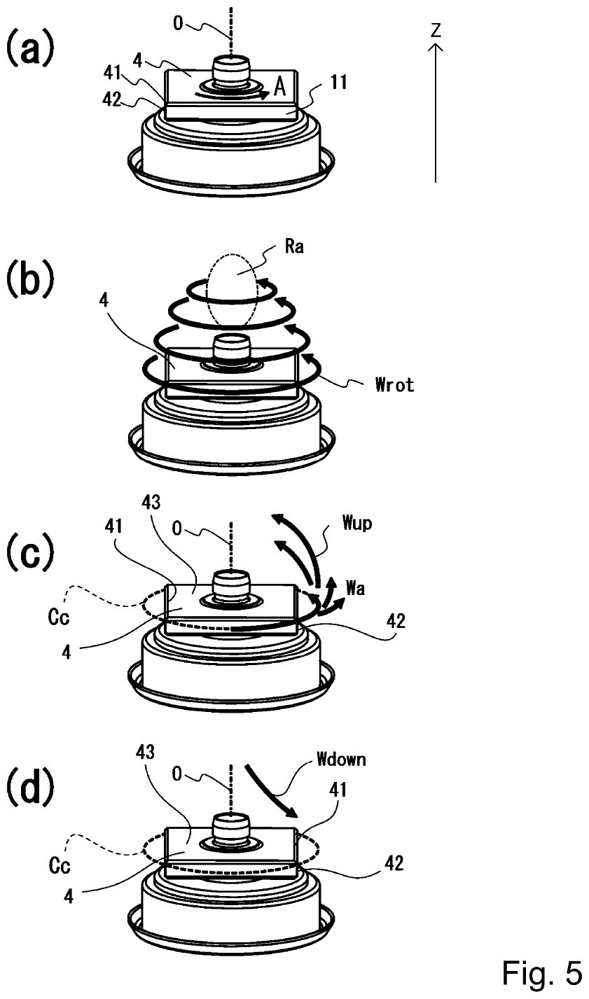

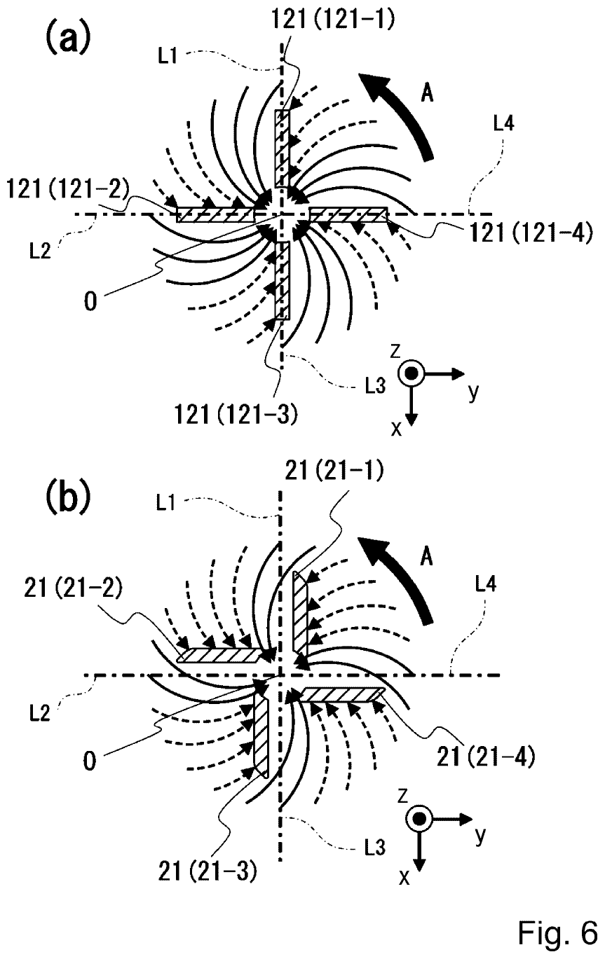

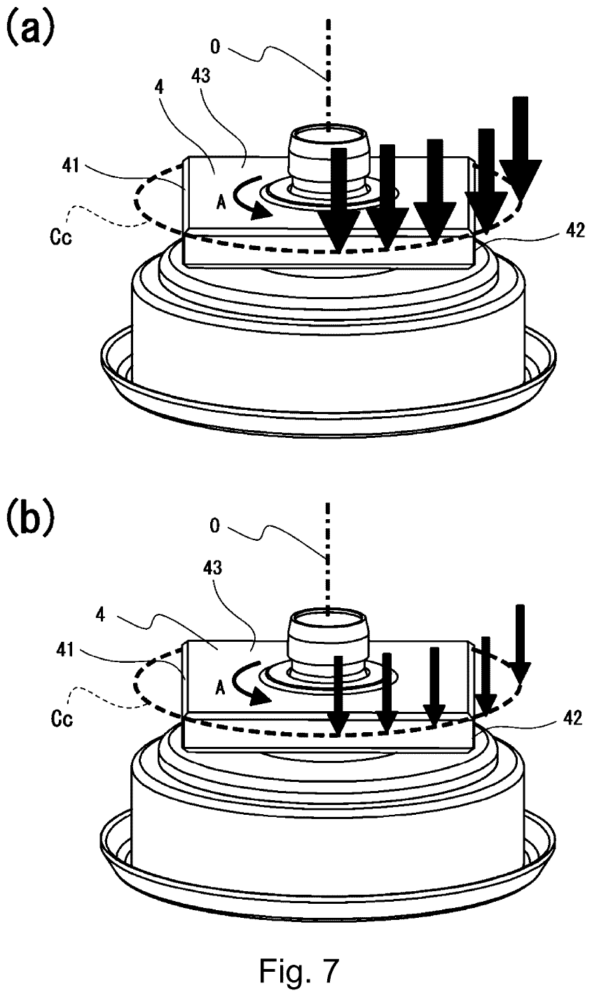

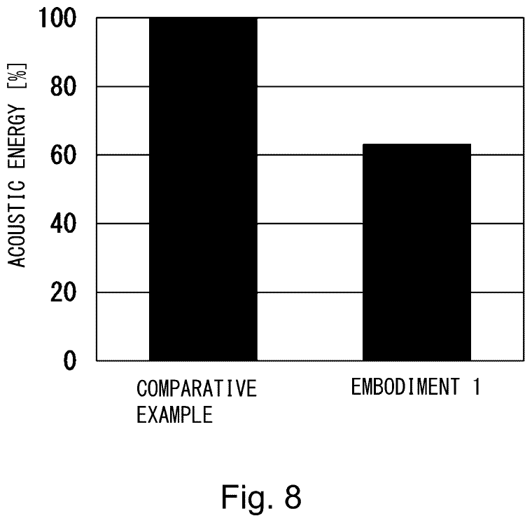

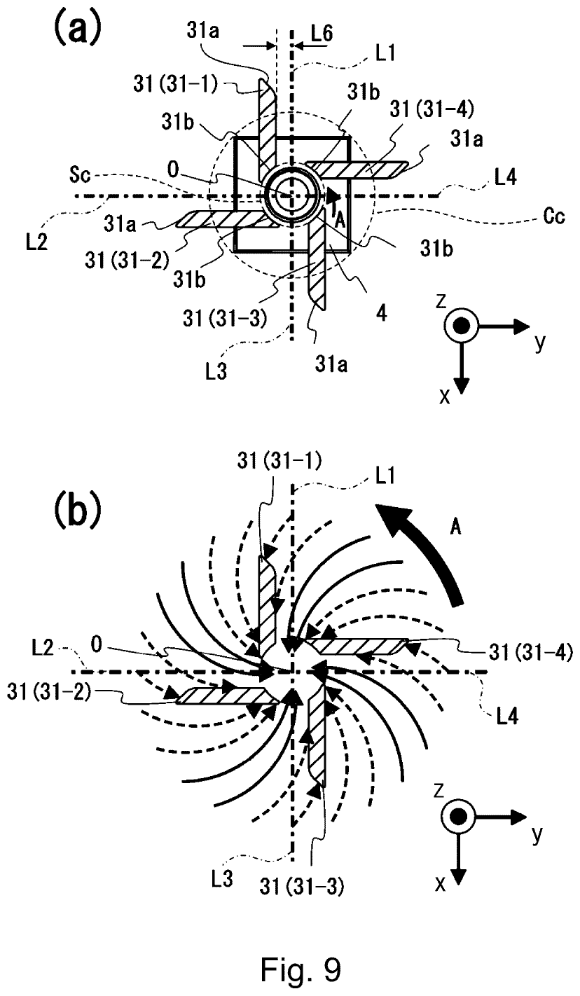

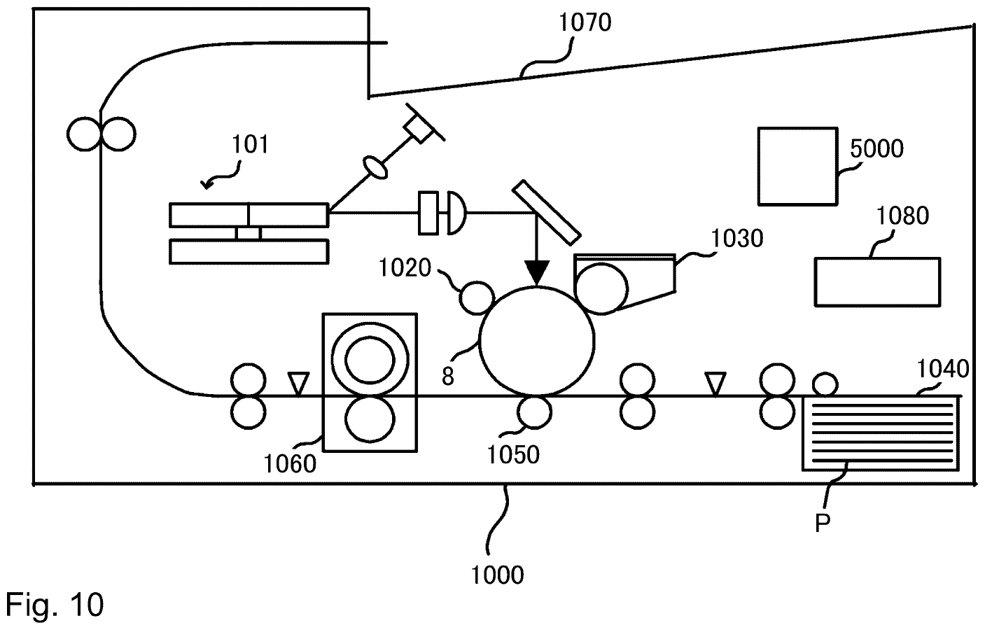

FIG. 3 is a perspective view showing how the cover member 20 is assembled to the optical box 9. As described above, the optical box 9 is provided with the positioning portion 91, and the cover member 20 is provided with the positioning portion 201, so that when the opening of the optical box 9 is covered by the cover member 20, the parts can be accurately positioned relative to each other. This makes it possible to stably obtain a reduction effect of the rotation sound caused by the rectifying plates 21 by relatively positioning the rectifying plates 21 provided on the cover member 20 to the rotational polygon mirror 4 accommodated in the optical box 9.

Incidentally, the configuration in which the opening of the optical box 9 is closed by the cover member 20 obtains the following effects. For example, by blocking both the leakage of the laser beam L from the inside of the scanning optical device 101 and the penetration of light from the outside, safe and stable deflection and scanning of the laser beam L can be achieved. Further, by sealing the opening of the optical box 9 with the cover member 20 and preventing the rotation sound generated by the rotation of the rotational polygon mirror 4 from leaking to the outside of the scanning optical device 101, a suppression effect of the operation sound when the image forming apparatus is in operation can be expected. In addition, by limiting the amount of air flowing in and out of the scanning optical device 101, the possibility of dust floating in the air adhering to optical elements such as the rotational polygon mirror 4 can be reduced. This prevents the occurrence of density unevenness in printed matter, which would otherwise result from a local decrease in the amount of light to be deflected and scanned with respect to the photosensitive drum 8 caused by dust adhering to the optical element.

### [Rectifying Plates]

The detailed shape of the rectifying plates 21 and their positional relationship with the rotational polygon mirror 4 will be described with reference to FIG. 4. Incidentally, FIG. 4 shows a state in which the cover member 20 is attached to the optical box 9. A rotational axis direction of the rotational polygon mirror 4 is defined as a z direction, and directions perpendicular to the z direction are defined as x and y directions. Incidentally, in embodiment 1, the rotational axis direction (arrow B in FIG. 1) of the photosensitive drum 8 is defined as the y direction.

Part (a) of FIG. 4 is a diagram showing the positional relationship between the rectifying plates 21 and the rotational polygon mirror 4 when the rotational polygon mirror 4 is viewed from a side surface (+x direction). The rectifying plates 21 are disposed above (+z direction) the rotational polygon mirror 4. More specifically, the rectifying plates 21 are configured of a plurality of ribs 21-1 to 21-4 projected from the ceiling wall surface 20a of the cover member 20 toward the rotational polygon mirror 4, and the plurality of ribs 21-1 to 21-4 project to a length that does not contact the top surface 43 of the rotational polygon mirror 4. That is, the rectifying plates 21 are provided between the ceiling wall surface 20a of the cover member 20 and the top surface 43 of the rotational polygon mirror 4.

Part (b) of FIG. 4 is a C-C sectional view of part (a) of FIG. 4, and shows the positional relationship between the rectifying plates 21 and the rotational polygon mirror 4 when the rotational polygon mirror 4 is viewed with respect to a −z direction. The rotational polygon mirror 4 is rotated in a counterclockwise direction (direction A) when deflecting and scanning the laser beam L (not shown). The rectifying plates 21 are formed by the plurality of independent linear ribs 21-1 to 21-4, and each of ribs 21-1 to 21-4 are disposed point symmetrically about a rotational axis center O of the rotational polygon mirror 4. In embodiment 1, the rectifying plates 21 are provided with four ribs 21-1 to 21-4.

In embodiment 1, the rectifying plates 21 are offset (translated) in an upstream side with respect to the rotational direction (direction A) of the rotational polygon mirror 4. Here, when viewed in the rotational axis direction as shown in part (b) of FIG. 4, four imaginary lines that pass through the rotational axis center O of the rotational polygon mirror 4, having rotational symmetry, and extending toward a circumscribing circle Cc (see FIG. 4) of the rotational polygon mirror 4, are denoted as L1, L2, L3, and L4. At this time, the four ribs 21-1 to 21-4 are not located on the imaginary lines L1 to L4, but are disposed at positions apart from a predetermined distance L5 in the upstream side with respect to the rotational direction to the imaginary lines L1 to L4, or in other words, at offset positions.

More specifically, the rib 21-1 is not located on the imaginary line L1, but is disposed at a position apart from the predetermined distance L5 in the upstream side with respect to the rotational direction to the imaginary line L1. The rib 21-2 is not located on the imaginary line L2, but is disposed at a position apart from the predetermined distance L5 in the upstream side with respect to the rotational direction to the imaginary line L2. The rib 21-3 is not located on the imaginary line L3, but is disposed at a position apart from the predetermined distance L5 in the upstream side with respect to the rotational direction to the imaginary line L3. The rib 21-4 is not located on the imaginary line L4, but is disposed at a position apart from the predetermined distance L5 in the upstream side with respect to the rotational direction to the imaginary line L4. Since the imaginary lines L1 and L2, the imaginary lines L2 and L3, the imaginary lines L3 and L4, and the imaginary lines L4 and L1 are perpendicular to each other, a rib and its adjacent rib in the rotational direction of the rotational polygon mirror 4 are apart by 90° in the rotational direction. That is, the four ribs 21-1 to 21-4 are provided radially about the rotational axis center O at intervals of 90 degrees.

Further, a surface 21a (one end portion) of the rectifying plates 21 at an end portion farther from the rotational axis center O is inclined. The surface 21a, for example of the rib 21-1, falls to the right. That is, of two surfaces 21c and 21d parallel to the imaginary line L1, the surface 21a is inclined so as to approach the rotational axis center O from the surface 21c closer to the imaginary line L1 toward the surface 21d farther from the imaginary line L1. The other ribs 21-2 to 21-4 are similarly inclined with respect to the imaginary lines L2 to L4 and the rotational axis center O. The surface 21a is inclined so that the air colliding with the surface 21a of the end portion can be smoothly rectified.

Incidentally, the inclination of the surface 21a may have the opposite inclination (fall to the left), and the surface 21a need not be perpendicular to the imaginary lines L1 to L4 (not inclined), as in the comparative example described later. Furthermore, the inclination of the surface 21a is not limited to a linear inclination when viewed in the rotational axis direction, as shown in part (b) of FIG. 4. The surface 21a may be inclined in a curved shape, for example, or in other words, the surface 21a may be a curved surface. Further, in embodiment 1, the rectifying plates 21 are configured so that the ribs 21-1 and 21-3 are parallel to the x direction, and the ribs 21-2 and 21-4 are parallel to the y direction, but the present invention is not limited to this. The ribs 21-1 to 21-4 do not have to be parallel to the x and y directions. That is, in FIG. 2, the rectifying plates 21 only need to be provided radially about the rotational axis center O of the rotational polygon mirror 4 with a predetermined offset, and the rectifying plates 21 may be provided in a state rotated in a range of 0° to 90° about the rotational axis center O from the state shown in FIG. 2.

Here, the circumscribing circle of the rotational polygon mirror 4 is denoted as Cc. As shown in part (b) of FIG. 4, the ribs 21-1 to 21-4 are provided so that the surface 21a of the ribs 21-1 to 21-4 are positioned outside the circumscribing circle Cc, and a surface 21b (an other end portion) is positioned inside the circumscribing circle Cc. This is because, if the surface 21a is provided inside the circumscribing circle Cc, the air flow traveling toward the outside of the corner portion 42 cannot be rectified, therefore the rising air flow cannot be rectified. Further, this is because, if the surface 21b is provided outside the circumscribing circle Cc, the air flow traveling toward the rotational axis center O cannot be rectified. Noise reduction may decrease both if the surface 21a is provided inside the circumscribing circle Cc, and if the surface 21b is provided outside the circumscribing circle Cc. Furthermore, the amount of offset (distance L5) described above may be determined within a range that satisfies the condition that the surface 21a is outside the circumscribing circle Cc and the surface 21b is inside the circumscribing circle Cc.

Further, the surface 21b of the end portion closer to the rotational axis center O of the rectifying plates 21 is a curved surface that constitutes a part of an imaginary circle Sc having the rotational axis center O as its center. By having the surface 21b form a part of the concentric imaginary circle Sc from the rotational axis center O, the air that is wound up spirally can be smoothly rectified by the surface 21b, thereby preventing turbulence from occurring near the rotational axis center O. For example, if the surface 21b of the rib 21-1 is shaped perpendicular (in other words, the rib is rectangular) to the imaginary line L1, a vortex may collide with the 90° corner portion of the surface 21b offset from the imaginary line L1, making it impossible to control the air flow. In embodiment 1, the surface 21b is a curved surface so as to form a part of the imaginary circle Sc, thereby preventing turbulence.

Incidentally, in embodiment 1, the number of ribs is four, and the ribs are provided at intervals of 90° about the rotational axis center O, but the present invention is not limited to this. The number of ribs may be five or more. Further, for example, the number of ribs may be the same as the number of surfaces of the rotational polygon mirror 4. In embodiment 1, the configuration is such that the number of ribs provided on the rectifying plates 21 is four, which is the same as the number of surfaces of the rotational polygon mirror 4. For example, if the rotational polygon mirror 4 has five surfaces, five ribs may be provided at positions offset by a predetermined distance in the upstream side in the rotational direction (arrow A) from five imaginary lines passing through the rotational axis center O and drawn radially about the rotational axis center O at intervals of 72°.

Thus, in embodiment 1, the plurality of ribs are disposed so as to have rotational symmetry about the rotational axis center O. Furthermore, the plurality of ribs are disposed at positions apart from the predetermined distance in the upstream side with respect to the rotational direction of the rotational polygon mirror 4 to a plurality of imaginary lines, of the same number as a number of the plurality of ribs, having rotational symmetry, and extending from the rotational axis center O toward the circumscribing circle Cc of the rotational polygon mirror 4. Incidentally, the plurality of ribs may be disposed at positions apart from the predetermined distance in a downstream side with respect to the rotational direction of the rotational polygon mirror 4 to the plurality of imaginary lines, of the same number as the number of the plurality of ribs, having rotational symmetry, and extending from the rotational axis center O toward the circumscribing circle Cc of the rotational polygon mirror 4, as will be explained in embodiment 2. In terms of rotational symmetry, the ribs 21-1 to 21-4 in embodiment 1 have a four-fold symmetry, whereas the rectifying plates having the above-mentioned five ribs has a five-fold symmetry.

Each of ribs has a lengthy shape parallel to the imaginary line corresponding to each of ribs, with an one end portion (21a) in the longitudinal direction disposed outside the circumscribing circle Cc, and an other end portion (21b) in the longitudinal direction disposed inside the circumscribing circle Cc. When viewed in the rotational axis direction, the one end portion (21a) is inclined from the upstream to the downstream in the rotational direction. This inclination may be formed by a curved surface. When viewed in the rotational axis direction, the other end portion (21b) is formed by a curved surface so as to form a part of a circumference of the imaginary circle Sc about the rotational axis of the rotational polygon mirror 4. The rotational polygon mirror 4 includes a plurality of reflecting surfaces 11 for reflecting the light beam, and a number of the plurality of ribs may be equal to a number of the plurality of reflecting surfaces 11. In a case in which the rotational polygon mirror 4 includes an even number of reflecting surfaces for reflecting the light beam, the plurality of ribs are disposed point symmetrically about the rotational axis.

### [Air Flow]

Here, the inventors of the present invention used a fluid analysis model to visualize the air flow when the rotational polygon mirror 4 is rotated. The air flows illustrated in the following explanation are all represented by schematic views showing analysis results. The air flow when the rotational polygon mirror 4 is rotated will be described in detail with reference to FIG. 5. Part (a) of FIG. 5 is a perspective view showing a state in which the rotational polygon mirror 4 is rotated in the counterclockwise direction (direction A) about the rotational axis center O. Part (b) of FIG. 5 shows a spiral air flow Wrot that occurs near the top surface 43 of the rotational polygon mirror 4 when the rotational polygon mirror 4 is rotated. The flow caused by the vortex core and the surrounding vortex filaments, which have the same rotational angular velocity when the rotational polygon mirror 4 is rotated, has the fastest flow velocity near the rotational axis center O, causing the pressure to be small, which results in a negative pressure region Ra (pump effect), shown by a dashed line.

Part (c) of FIG. 5 shows a spiral rising air flow Wup that occurs when the rotational polygon mirror 4 is rotated. An air Wa is strongly pushed out near the edge portion 41 by the corner portion 42 formed by the adjacent reflecting surfaces 11 of the rotational polygon mirror 4, mainly in the tangential direction of the circumscribing circle Cc of the rotational polygon mirror 4. The air Wa is drawn in spirally toward the rotational axis center O due to the influence of the negative pressure region Ra near the rotational axis center O, and rapidly rises near the rotational polygon mirror 4.

Part (d) of FIG. 5 shows a descending air flow Wdown that occurs when the rotational polygon mirror 4 is rotated. As shown in part (c) of FIG. 5, the air (Wup) that has risen once travels toward the center of the rotational polygon mirror 4 along the rectifying plates 21 and the ceiling wall surface 20a of the cover member 20 (neither of which are shown), and begins to descend near the center as if blowing onto the rotational polygon mirror 4 from above. The descending air flows again along the rotational axis center O and the top surface 43 of the rotational polygon mirror 4 toward the circumscribing circle Cc of the rotational polygon mirror 4. However, a part of the air descends near the edge portion 41 and collides with the air Wup that is pushed upward by the corner portion 42 formed by the reflecting surfaces 11 of the rotating rotational polygon mirror 4, causing turbulence.

### [Air Flow and Rotation Sound]

Next, the relationship between the air flow described above and the operation sound (rotation sound) generated when the rotational polygon mirror 4 is rotated will be described. One of the causes of the rotation sound is the spiral air Wrot occurring near the top surface 43 of the rotational polygon mirror 4, and the air Wup that is pushed upward in a spiral by the corner portion 42 formed by the reflecting surfaces 11 of the rotational polygon mirror 4 near the edge portion 41. The spiral airs Wrot and Wup are divided by the rectifying plates 21 and the vortex is made smaller, thereby suppressing the generation of rotation sound.

Here, another cause of the rotation sound is turbulence generated by the collision of the air Wdown descending near the edge portion 41 with the spiral air Wup that is pushed upward by the corner portion 42 formed by the reflecting surfaces 11 of the rotating rotational polygon mirror 4. The fact that the rotation sound is caused by turbulence can also be inferred from the fact that when the shear flow component in the rotational axis direction of the rotational polygon mirror 4 is large, the fluid fluctuation (pressure fluctuation) becomes large. To reduce this turbulence, the following measures are effective. That is, in order to reduce the collision energy between the airs, it is effective to suppress the flow velocity of the air Wdown descending toward the edge portion 41, and to rectify the air Wup toward the rotational axis center O by the rectifying plates 21 before the air Wup that is rising in a spiral begins to descend.

### [Air Flow and Rectifying Plates]

The relationship between the air flow and the rectifying plates 21 when the rotational polygon mirror 4 is rotated will be described with reference to FIG. 6. FIG. 6 is a sectional view of the rectifying plates 21 when the rotational polygon mirror 4 is viewed with respect to the −z direction. Part (a) of FIG. 6 shows the air flow generated near rectifying plates 121 in the comparative example when the rotational polygon mirror 4 (not shown) is rotated in the counterclockwise direction (direction A). Part (b) of FIG. 6 shows the air flow generated near the rectifying plates 21 in embodiment 1 when the rotational polygon mirror 4 (not shown) is rotated in the counterclockwise direction (direction A).

Here, the rectifying plates 121 in the comparative example are provided with four independent ribs 121-1 to 121-4. The rectifying plates 121 in the comparative example are not offset in the upstream side with respect to the rotational direction (direction A) of the rotational polygon mirror 4. That is, each of four ribs 121-1 to 121-4 are provided on the imaginary lines L1 to L4 passing through the rotational axis center O of the rotational polygon mirror 4. Further, for example, both end portions of the rib 121-1 in the direction (longitudinal direction) along the imaginary line L1 are perpendicular to the imaginary line L1, and the shape of the rib 121-1 is rectangular. The same applies to the other ribs 121-2 to 121-4.

When the rotational polygon mirror 4 (not shown) is rotated, the air is drawn in spirally toward the rotational axis center O, as described above. During the process of being drawn in spirally, the air (dashed arrows in parts (a) and (b) of FIG. 6) flowing along the rectifying plates 21 and 121 has its air flow rectified by the rectifying plates 21 and 121. This decreases the air flow velocity, and the air flows toward the rotational axis center O along the rectifying plates 21 and 121. On the other hand, the air (solid arrows in parts (a) and (b) of FIG. 6) that is drawn directly toward the rotational axis center O without flowing along the rectifying plates 21 and 121 is not rectified, and the flow velocity remains unattenuated.

As described above, the more rectified air there is, the smaller the shear flow component with respect to the rotational axis direction of the rotational polygon mirror 4 can be, thereby obtaining a high noise reduction effect. Here, if we compare the comparative example with embodiment 1, it can be seen that the amount of air flowing along the rectifying plates 21 and 121 is greater in embodiment 1 (the number of arrows indicated by dashed lines is greater in embodiment 1), and the air can be efficiently rectified toward the rotational axis center O. Conversely, the amount of air flowing directly toward the rotational axis center O without flowing along the rectifying plates 21 and 121 is greater in the comparative example (the number of arrows indicated by solid lines is greater in the comparative example).

### [Air Flow Velocity]

The flow velocity of wind (air) blowing against the edge portion 41 of the rotational polygon mirror 4 will be described with reference to FIG. 7. As described above, the inventors of the present invention have used a fluid analysis model to visualize the air flow when the rotational polygon mirror 4 is rotated.

Part (a) of FIG. 7 is a schematic view showing simulation results of the flow velocity of the wind blowing with respect to the rotational axis direction against the edge portion 41 of the rotational polygon mirror 4 after being rectified by the rectifying plates 121 in the comparative example, and part (b) of FIG. 7 is a schematic view showing simulation results of the flow velocity of the wind blowing in the rotational axis direction against the edge portion 41 of the rotational polygon mirror 4 after being rectified by the rectifying plates 21 in embodiment 1, both of which are represented by the thickness of the arrows. The thicker the arrow, the faster the flow velocity, and the thinner the arrow, the slower the flow velocity. According to these results, it can be seen that the flow velocity in the rotational axis direction of the wind blowing against the vicinity of the edge portion 41 of the rotational polygon mirror 4 is slower in embodiment 1 than in the comparative example. This is because, as described above, a high rectifying effect is obtained by providing the rectifying plates 21.

### [Noise Measurement Results]

FIG. 8 is a graph showing results of a noise measurement test carried out using the scanning optical device 101 in the comparative example and embodiment 1. In the test, sound collection microphones were placed around the scanning optical device 101, and the acoustic energy [%] of the sound measured by the sound collection microphones was graphed. According to these results, when the acoustic energy of the sound measured in the comparative example is set to be 100%, the acoustic energy in embodiment 1 is approximately 60%. That is, it can be seen that the acoustic energy of the scanning optical device 101 in embodiment 1 is decreased to approximately 60% of that in the comparative example. This is because, as described above, the high rectifying effect obtained by providing the rectifying plates 21 resulted in suppressing the occurrence of turbulence.

As described above, the rectifying plates 21 having the plurality of independent linear ribs 21-1 to 21-4 are provided in the vicinity of the rotational polygon mirror 4. This makes it possible to both divide the vortex flow and suppress turbulence. That is, it is possible to divide the vortex flow circulating in an annular shape that is generated by being drawn in while rising with respect to the rotational axis center of the rotational polygon mirror 4. In addition, it is possible to suppress turbulence caused by the collision between the air descending near the edge portion 41 of the rotational polygon mirror 4 and the spiral air that is pushed upward by the corner portion 42 formed by the reflecting surfaces 11 of the rotational polygon mirror 4. This makes it possible to realize an optical scanning device with improved quietness.

As described above, according to embodiment 1, it is possible to improve quietness by using an inexpensive configuration to both divide the vortex flow generated by the rotation of the rotational polygon mirror, and to suppress the wind blowing against the edge portion of the rotational polygon mirror.

### Embodiment 2

In embodiment 2, the configuration of rectifying plates 31 and the air flow when the rotational polygon mirror 4 is rotated will be described. Other device configurations and the arrangement of members are common, so the description of each function is omitted and only the different configurations are described. Further, in the following description, the same reference numerals will be used to designate the same members as those in embodiment 1.

### [Rectifying Plates]

Part (a) of FIG. 9 is a sectional view showing the positional relationship between the rectifying plates 31 and the rotational polygon mirror 4 when the rotational polygon mirror 4 is viewed with respect to the −z direction. The rotational polygon mirror 4 is rotated in the counterclockwise direction (direction A) when deflecting and scanning the laser beam L (not shown). The rectifying plates 31 have a plurality of independent linear ribs, and are disposed point symmetrically with respect to the rotational axis center O of the rotational polygon mirror 4. In embodiment 2, the rectifying plates 31 are provided with four ribs 31-1 to 31-4.

In embodiment 2, the rectifying plates 31 are offset in the downstream side with respect to the rotational direction of the rotational polygon mirror 4. That is, the four ribs 31-1 to 31-4 are not located on the imaginary lines L1 to L4 which pass through the rotational axis center O of the rotational polygon mirror 4, but are disposed at positions apart from a distance L6 in the downstream side with respect to the rotational direction to the imaginary lines L1 to L4.

More specifically, the rib 31-1 is not located on the imaginary line L1, but is disposed at a position apart from the predetermined distance L6 in the downstream side with respect to the rotational direction to the imaginary line L1. The rib 31-2 is not located on the imaginary line L2, but is disposed at a position apart from the predetermined distance L6 in the downstream side with respect to rotational direction to the imaginary line L2. The rib 31-3 is not located on the imaginary line L3, but is disposed at a position apart from the predetermined distance L6 in the downstream side with respect to the rotational direction to the imaginary line L3. The rib 31-4 is not located on the imaginary line L4, but is disposed at a position apart from the predetermined distance L6 in the downstream side with respect to the rotational direction to the imaginary line L4.

Further, by inclining a surface 31a of an end portion of the rectifying plates 31 on the side farther from the rotational axis center O in a similar manner as the surface 21a in embodiment 1, the air colliding with the surface 31a of the end portion can be smoothly rectified. Further, as in embodiment 1, the surface 31b of the end portion of the rectifying plates 31 closer to the rotational axis center O forms a curved surface with a part of the concentric imaginary circle Sc about the rotational axis center O of the rectifying plates 31, thereby preventing turbulence from occurring near the rotational axis center O.

### [Air Flow and Rectifying Plates]

Further, as in embodiment 1, the inventors of the present invention have used a fluid analysis model to visualize the air flow in embodiment 2 when the rotational polygon mirror 4 is rotated. Part (b) of FIG. 9 shows the air flow occurring near the rectifying plates 31 in embodiment 2 when the rotational polygon mirror 4 is rotated, and is a sectional view of the rectifying plates 31 when the rotational polygon mirror 4 is viewed with respect to the −z direction. When the rotational polygon mirror 4 (not shown) is rotated in the counterclockwise direction (direction A), the air is drawn in spirally toward the rotational axis center O, as described above.

During the process of being drawn in spirally, the air (dashed arrows in part (b) of FIG. 9) flowing along the rectifying plates 31 is rectified by the rectifying plates 31, which reduces its flow velocity, so the air flows along the rectifying plates 31 toward the rotational axis center O. On the other hand, the air (solid arrows in part (b) of FIG. 9) that is drawn directly toward the rotational axis center O without flowing along the rectifying plates 31 is not rectified, and the flow velocity remains unattenuated.

As described above, it is considered that the more rectified air there is, the smaller the shear flow component with respect to the rotation of the rotational polygon mirror 4 can be, thereby obtaining a high noise reduction effect. Here, if we compare the air flow in embodiment 2 shown in part (b) of FIG. 9 with the air flow in the comparative example shown in part (a) of FIG. 6 described above, it can be seen that more air collides with the rectifying plates 31 in embodiment 2, and that embodiment 2 is able to efficiently rectify the air flow toward the rotational axis center O.

Here, according to the results of the fluid simulation performed in embodiment 2, the flow velocity in the rotational axis direction of the wind blowing against the vicinity of the edge portion 41 of the rotational polygon mirror 4 was smaller in embodiment 2 than in the comparative example, as in embodiment 1. This is because, as described above, a high rectifying effect was obtained by providing the rectifying plates 31.

Further, the inventors of the present invention also carried out the noise measurement test using the scanning optical device 101 in embodiment 2. Test conditions were the same as those in the comparative example and embodiment 1. According to these results, embodiment 2 was able to achieve the same level of acoustic energy (60%) as the scanning optical device 101 in embodiment 1. This is because, as described above, the rectifying effect enhanced by providing the rectifying plates 31 resulted in suppressing the occurrence of turbulence.

As described above, in embodiment 2, the rectifying plates 31 formed by the plurality of independent linear ribs are disposed near the rotational polygon mirror 4. This makes it possible to divide the vortex flow circulating in an annular shape that is generated by drawing the vortex flow upward with respect to the rotation center. Further, turbulence caused by the collision between the air descending near the edge portion 41 of the rotational polygon mirror 4 and the spiral air that is pushed upward by the corner portion 42 formed by the reflecting surfaces 11 of the rotational polygon mirror 4 can be suppressed. Thus, both the division of the vortex flow and suppression effect of turbulence can be obtained. This makes it possible to realize an optical scanning device with improved quietness.

As described above, according to embodiment 2, it is possible to improve quietness by using an inexpensive configuration to both divide the vortex flow generated by the rotation of the rotational polygon mirror, and suppress the wind blowing against the edge portion of the rotational polygon mirror.

### Embodiment 3

### [Description of Laser Beam Printer]

FIG. 10 shows a schematic block of a laser beam printer as an example of the image forming apparatus. A laser beam printer 1000 (hereinafter referred to as printer 1000) is provided with the photosensitive drum 8 as a photosensitive member, a charging unit 1020, and a developing unit 1030. The photosensitive drum 8 is an image bearing member on which the electrostatic latent image is formed. The charging unit 1020 uniformly charges the photosensitive drum 8. The scanning optical device 101, which is an exposure means, scans the photosensitive drum 8 with a laser beam corresponding to image data to form the electrostatic latent image. The developing unit 1030 develops the electrostatic latent image formed on the photosensitive drum 8 with toner to form a toner image. The toner image formed on the photosensitive drum 8 (image bearing member) is transferred by a transfer unit 1050 to a sheet P as a recording material supplied from a cassette 1040, and the unfixed toner image transferred to the sheet P is fixed by a fixing device 1060 and discharged onto a tray 1070. The photosensitive drum 8, the charging unit 1020, the developing unit 1030, and the transfer unit 1050 constitute an image forming unit. Further, the printer 1000 is provided with a power source device 1080, and supplies power from the power source device 1080 to driving units such as a motor and a control unit 5000.

The control unit 5000 is provided with a CPU (not shown), and controls the image forming operation by the image forming unit, a conveying operation of the sheet P, and the like. When the printer 1000 finishes a print operation, after a predetermined time has elapsed, the printer 1000 transitions to a standby state in which the printer 1000 can immediately execute a print operation. After a further predetermined time has elapsed, the printer 1000 transitions from the standby state to a sleep state, which is a low power consumption mode, so as to reduce power consumption during standby. The printer 1000 has three states: the sleep and standby states, which are a second mode, and a print state, which is a first mode, and the control unit 5000 causes the printer 1000 to transition to each of these states.

The scanning optical device 101 includes the cover member 20 on which the rectifying plates 21 in embodiment 1 or the rectifying plates 31 in embodiment 2 are provided. Incidentally, the image forming apparatus to which the scanning optical device 101 of the present invention can be applied is not limited to the configuration exemplified in FIG. 10.

As described above, according to embodiment 3, it is possible to improve quietness by using an inexpensive configuration to both divide the vortex flow generated by the rotation of the rotational polygon mirror and suppress the wind blowing against the edge portion of the rotational polygon mirror.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-151757 filed on Sep. 3, 2024, which is hereby incorporated by reference herein in its entirety.

What is claimed is:

1. A scanning optical device comprising:
a light source configured to emit a light beam;
a rotational polygon mirror configured to deflect and scan the light beam emitted from the light source;
a scanning lens configured to image the light beam defected and scanned by the rotational polygon mirror on a scanned surface;
an optical box including an opening and configured to accommodate the light source, the rotational polygon mirror, and the scanning lens; and
a cover configured to cover the opening,
wherein on an opposite surface of the cover opposed to the rotational polygon mirror in a state in which the cover covers the opening, a plurality of ribs projected from the opposite surface toward the rotational polygon mirror are formed,
wherein as viewed in a rotational axis direction of the rotational polygon mirror, the plurality of ribs are
disposed so as to have rotational symmetry about a rotational axis of the rotational polygon mirror,
extended from the rotational axis toward a circumscribing circle of the rotational polygon mirror, and
disposed at positions apart from a predetermined distance in an upstream side or a downstream side with respect to a rotational direction of the rotational polygon mirror to a plurality of imaginary lines, of the same number as a number of the plurality of ribs, having rotational symmetry about the rotational axis, and
wherein as viewed in the rotational axis direction, each of ribs has a lengthy shape parallel to the imaginary line corresponding to each of ribs, one end portion thereof in a longitudinal direction of the rib is disposed outside the circumscribing circle and the other end portion thereof in the longitudinal direction of the rib is disposed inside the circumscribing circle.

2. The scanning optical device according to claim 1, wherein as viewed in the rotational axis direction, the other end portion is inclined from an upstream toward a downstream in the rotational direction.

3. The scanning optical device according to claim 2, wherein the inclination is formed by a curved surface.

4. The scanning optical device according to claim 1, wherein as viewed in the rotational axis direction, the other end portion is formed by a curved surface so as to form a part of a periphery of an imaginary circle about the rotational axis.

5. The scanning optical device according to claim 1, wherein the rotational polygon mirror includes a plurality of reflecting surfaces for reflecting the light beam, and
wherein a number of the plurality of ribs is equal to a number of the plurality of reflecting surfaces.

6. The scanning optical device according to claim 1, wherein in a case in which the rotational polygon mirror includes an even number of reflecting surfaces for reflecting the light beam, the plurality of ribs are disposed point symmetrically about the rotational axis.

7. The scanning optical device according to claim 1, wherein the rotational polygon mirror includes a top surface opposite to the opposite surface of the cover in a state in which the cover covers the opening.

8. An image forming apparatus for perform image formation on a recording material, the image forming apparatus comprising:
a photosensitive member including a scanned surface; and
a scanning optical device according to claim 1, the scanning optical device scanning the photosensitive member with a light beam.
